(19) United States
(12) Patent Application Publication
(10) Pub. No.: US 2026/0214658 A1
(43) Pub. Date: Jul. 23, 2026

(54) SYSTEMS, METHODS, AND DEVICES FOR ENHANCED BANDWIDTH PART (BWP) CONFIGURATION AND OPERATION

(71) Applicant: Apple Inc., Cupertino, CA (US)

(72) Inventors: Seyed Ali Akbar FAKOORIAN, San Diego, CA (US); Parisa BABAHEIDARIAN, Saratoga, CA (US); Xiang CHEN, Palo Alto, CA (US); Fangli XU, Beijing (CN); Dawei ZHANG, Saratoga, CA (US); Hongbo YAN, Vista, CA (US); Wei ZENG, Saratoga, CA (US)

(21) Appl. No.: 19/451,932

(22) Filed: Jan. 16, 2026

Related U.S. Application Data
(60) Provisional application No. 63/746,876, filed on Jan. 17, 2025.

(51) Int. Cl. H04W 72/0457; H04L 27/26; H04W 56/00; H04W 72/231; H04W 74/0833; H04W 76/20

(52) U.S. Cl. CPC H04W 72/0457; H04L 27/26025; H04L 27/2605; H04W 56/0015; H04W 72/231; H04W 74/0833; H04W 76/20

(57) ABSTRACT

Described herein are techniques for enhanced bandwidth part (BWP) configuration and operation. A base station can allocate BWPs to UEs based on a cell-specific subcarrier spacing (SCS), cyclic prefix (CP), and one or more radio resource control (RRC) parameters. BWP switching can be based on RRC signaling, downlink control information (DCI), inactivity timer, SCS configuration, and/or RACH procedure. Inactivity timers can be configured according to a paired or unpaired spectrum BWP configuration. A common downlink and/or uplink BWP can be implemented for UEs in an idle mode, during RRC configuration or reconfiguration, and/or for cell-specific RACH procedures. These and many other features and examples are described herein.

### CROSS-REFERENCE TO RELATED APPLICATIONS

This application claims the benefit of U.S. Provisional Application No. 63/746,876, filed Jan. 17, 2025, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling user equipment (UE) and network devices, such as base stations, to communicate with one another. Such communications can involve procedures to allocate and use time and frequency resources for wireless communications.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

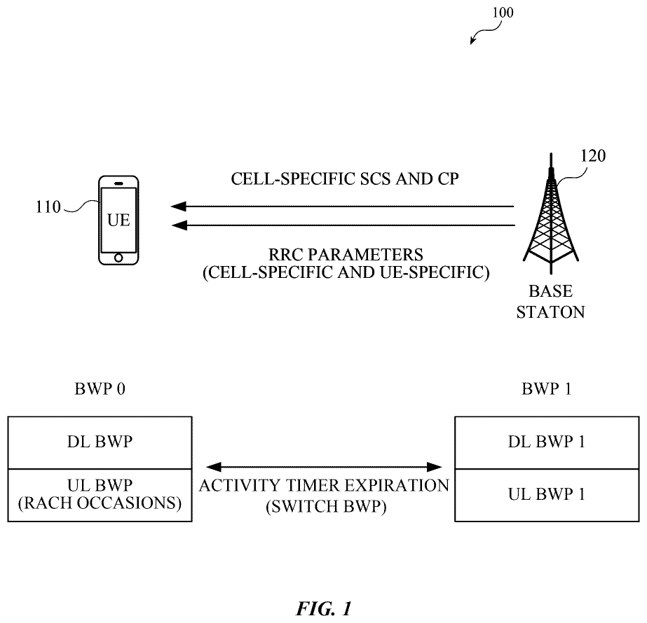

FIG. 2 is a diagram of an example network according to one or more implementations described herein.

FIG. 3 is a diagram of an example of a master cell group (MCG) and a secondary cell group (SCG) according to one or more implementations described herein.

FIG. 4 is a diagram of an example process for enhanced bandwidth part (BWP) configuration and/or operation according to one or more implementations described herein.

FIG. 5 is a diagram of an example of BWP switching based on timer expiration according to one or more implementations described herein.

FIG. 6 is a diagram of an example of a table for downlink control information (DCI) and timer-based BWP switching according to one or more implementations described herein.

FIG. 7 is a diagram of an example of a BWP configuration with physical random access channel (PRACH) occasions according to one or more implementations described herein.

FIG. 8 is a diagram of an example of a BWP configuration with common downlink and uplink BWPS for random access channel (RACH) procedures according to one or more implementations described herein.

FIG. 9 is a diagram of an example of components of a device according to one or more implementations described herein.

FIG. 10 is a diagram of example interfaces of baseband circuitry according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 12 is a diagram of an example process for enhanced BWP configuration and/or operation according to one or more implementations described herein.

FIG. 13 is a diagram of an example process for enhanced BWP configuration and/or operation according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless communication networks can include user equipment (UE) capable of communicating with base stations and/or other network devices. The UE and base station can communicate with one another using time and frequency resources allocated for uplink and downlink communications. Examples of such communications can involve a variety of channels and signals.

A carrier bandwidth can include a frequency band designated as carrier for a sending and receiving a wireless channel or signal. A carrier bandwidth can include multiple bandwidth parts (BWP). A BWP can include a contiguous set of physical resource blocks that is selected from a contiguous subset of the common resource blocks for a given numerology on a given carrier. Physical channels can include a physical downlink control channel (PDCCH), physical downlink shared channel (PDSCH), physical uplink control channel (PUCCH), physical uplink shared channel (PUSCH), and more.

A physical channel or signal can be configured on a per-BWP basis. The configuration of different BWPs parts can be different. For example, two BWPs can be configured to a particular UE, using different uplink waveforms. One BWP can be configured using a cyclic prefix (CP) orthogonal frequency-division multiplexing (OFDM) (CP-OFDM) and the other BWP can be configured using a Discrete Fourier transform (DFT) spread OFDM (DFT-s-OFDM) waveform. This can enable a network to support UEs that have different capabilities and requirements.

While multiple BWPs can be configured for downlink and uplink, only one BWP can be active at a time. Switching from using one BWP to using another BWP can be referred to as BWP selection or BWP switching. The mechanism for BWP switching can be based-on a channel type or procedure (e.g., a random access channel (RACH) or random access (RA) procedure), timing, radio resource control (RRC) signaling, or downlink control information (DCI). For example, an initial BWP can be selected during a RA procedure, and the RA procedure can result in multiple BWPs being configured and a first BWP being selected. One or more BWP switching events can occur in response to RRC signaling and/or DCI, and BWP switching to a default or fallback BWP can occur in response to the expiration of an inactivity timer.

Currently available technologies for allocating a BWP for uplink and downlink communications can involve the configuration of numerous parameters. Examples of such parameters can include downlink bandwidth size, uplink bandwidth size, monitoring periodicity, modulation and coding scheme (MCS), number of multiple-input multiple-output (MIMO) layers, scheduling offset, priority indicator, CP, subcarrier spacing (SCS), and more. Such an approach can give rise a level of complexity that is overly cumbersome, inefficient, and otherwise difficult or impractical to implement.

One or more of the techniques, described herein, include solutions for improved BWP configuration and operation. These solutions can include designating some BWP configuration parameters as cell-specific parameters as opposed to UE-specific parameters. Examples of such parameters can include SCS and/or CP. Further, certain types or categories of BWP configuration parameters, along with one or more exceptions, can be implemented as cell-specific parameters instead of UE-specific parameters. For instance, all RRC parameters used for BWP configuration can be implemented on a cell-specific basis (as opposed to a UE-specific basis) with one or more exceptions. Examples of such exceptions can include RRC parameters associated with downlink/uplink bandwidth size, PDCCH monitory periodicity, MCS parameters or tables (e.g., a mcs-Table parameter), frequency domain parameters for downlink reception and/or UL transmission (e.g., number of multiple-input multiple-output layers, scheduling offset, priority indicator, CP, subcarrier spacing (SCS), and more.).

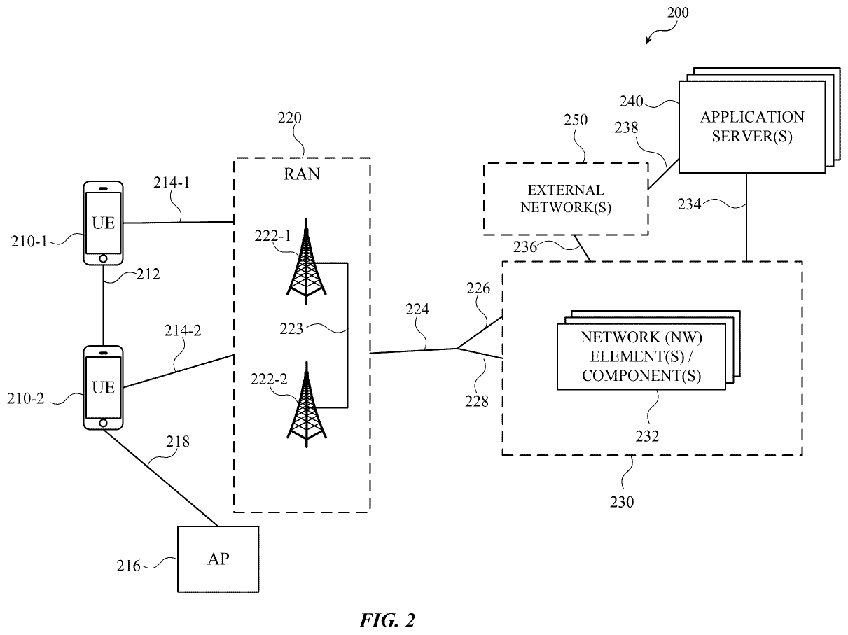

FIG. 2 is a diagram of an example 100 of an overview according to one or more implementations described herein. As shown, example 100 can include UE 110 and base station 120. UE 110 and base station 120 can operate with one another using a cell-specific SCS and CP (e.g., a SCS and CP that is common for UEs communicating with base station 120). UE 110 can be configured with RRC configuration parameters, which can include a combination of cell-specific parameters and UE-specific parameters. For example, UE-specific RRC parameters can include downlink bandwidth size, uplink bandwidth size, monitoring periodicity, modulation and coding scheme (MCS), number of multiple-input multiple-output (MIMO) layers, scheduling offset, priority indicator, CP, subcarrier spacing (SCS), and more. The remaining RRC parameters can be cell-specific parameters that are commonly implemented for UEs communicating with base station 120.

Base station 120 can allocate BWPs to UE 110 (e.g., BWP 0 and BWP 1). The BWPs can be paired spectrum or unpaired spectrum BWPs. Some BWPs can include initial BWP functionality, such as having one or more RACH occasions allocated to one or more UEs. UE 110 can switch between BWPs based on DCI, the expiration of one or more BWP inactivity timers, or another type of BWP switching trigger. These and many other features and examples are described below with reference to the remaining Figures.

FIG. 2 is an example environment 200 in which one or more of the techniques described herein can be implemented. Example environment 200 can include UEs 210-1, 210-2, etc. (referred to collectively as “UEs 210” and individually as “UE 210”), a radio access network (RAN) 220, a core network (CN) 230, application servers 240, external networks 250.

The systems and devices of example environment 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example environment 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards, and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include Internet of Things (IoT) devices (or IoT UEs) that can implement narrowband (NB) communications and that can comprise, for example, a network access layer designed for low-power IoT applications utilizing short-lived UE connections.

Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can communicate and establish a connection with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). A network node can be referred to herein as a base station 222. In such a scenario, one network node can operate as a master node (MN) and the other as the secondary node (SN). The MN and SN can be connected via a network interface, and at least the MN can be connected to the CN 230. In some implementations, a base station (as described herein) can be an example of network node 222. In some scenarios, RAN 220 can coordinate with core network 230 via interfaces 224, 226, and/or 228.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection interface 218 can comprise a local wireless connection, such as a connection consistent with any IEEE 802.11 protocol, and AP 216 can comprise a wireless fidelity (Wi-Fi®) router or other access point device. While not explicitly depicted in FIG. 2, AP 216 can be connected to another network (e.g., the Internet) without connecting to RAN 220 or CN 230.

One or more of the techniques described herein include solutions for enhanced bandwidth part (BWP) configuration and operation. Base station 222 can allocate BWPs to UEs 210 based on a cell-specific subcarrier spacing (SCS), cyclic prefix (CP), and one or more radio resource control (RRC) parameters. BWP switching can be based on RRC signaling, DCI, inactivity timer, SCS configuration, and/or RACH procedure. Inactivity timers can be configured according to a paired or unpaired spectrum BWP configuration. A common downlink and/or uplink BWP can be implemented for UEs in an idle mode, during RRC configuration or reconfiguration, and/or for cell-specific RACH procedures. These and many other features and examples are described herein.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 1G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells. A RAN node can generally be referred to herein as base station 222.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 1 (L1) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block can comprise a collection of resource elements; in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information feedback from any of UEs 210. The downlink resource assignment information can be sent on the PDCCH used for (e.g., assigned to) each of UEs 210.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN (5GC), and/or one or more additional or alternative types of CNs.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

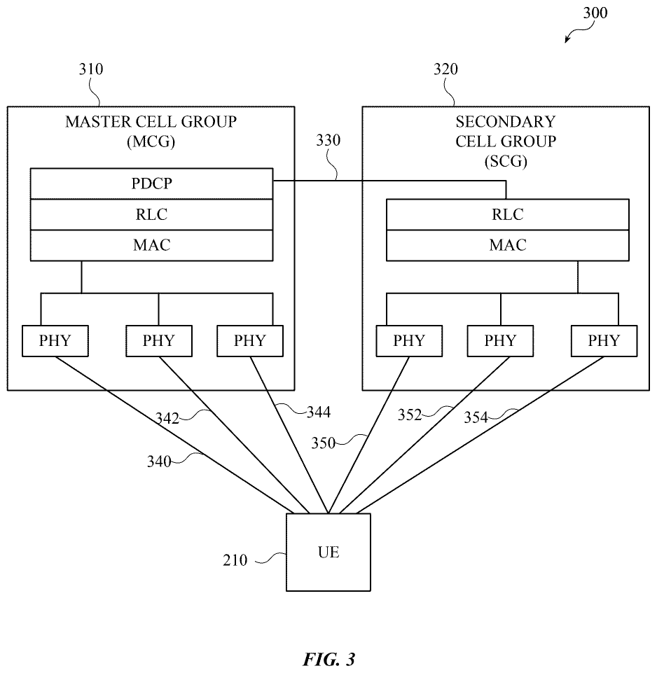

FIG. 3 is a diagram of an example 300 of master cell group (MCG) 310 and secondary cell group (SCG) 320 according to one or more implementations described herein. MCG 310 can include a group of cells associated with a master node, comprising a primary cell (PCell) and one or more secondary cells (SCells). SCG 320 can include a group of serving cells associated with a secondary node, comprising a primary cell of a secondary cell group (PSCell) and optionally one or more SCells.

MCG 310 can be implemented by one or more base stations 222 and/or another type of RAN node or network access point. MCG 310 can include one or more layers. Examples of such layers can include a PDCP layer, an RLC layer, a MAC layer, and multiple PHY layers. Each PHY layer can correspond to a different implementation of a cell with respect to UE 210. Additionally, or alternatively, the PHY layers can operate in combination (e.g., be managed, controlled by, etc.) the PDCP, RLC, and MAC layers. In some implementations, one PHY layer 340 can operate as a PCell or a special cell (SpCell) and other PHY layers 342 and 344 can operate as SCells to the PCell.

SCG 320 can be implemented by one or more base stations 222 and/or another type of RAN node or network access point. SCG 320 can include multiple layers, including an RLC layer, a MAC layer, and multiple PHY layers 350, 352, and 354. SCG 320 may not include a PDCP layer but instead can rely on the PDCP layer of MCG 310 via connection 330. Similar to the PHY layers of MCG 310, the PHY layers of SCG 320 can each function or operate as a cell with respect to UE 210. In some implementations, one PHY layer 350 can operate as a primary cell (PCell) to PHY layers 352 and 354, which can operate as secondary cells to the PCell of PHY layer 350. Additionally, MCG 310 and SCG 320 can each include a PCell (e.g., 340 and 350), and a PCell can be referred to herein as a special cell or special primary cell, represented as SpCell. Further, a SCell, of either MCG 310 or SCG 320, can operate as a scheduling secondary cell (sSCell) configured to provide configuration, scheduling, activation, deactivation, and other functions or commands toward a SpCell of either MCG 310 or SCG 320.

MCG 310 and SCG 320 can be involved in a dual connectivity scenario with UE 210, in which case a random access channel (RACH) procedure, and the like, can be directed to MCG 310. MCG 310 and SCG 320 can also implement a standalone (SA) and/or a non-standalone (NSA) network environment for UE 210. In a SA network environment, MCG 310 and SCG 320 can communicate with UE 210 using 5G NR communication standards, 6G communications standards, 7G communication standards, and more. In an NSA network environment, MCG 310 and SCG 320 can communicate with UE 210 using a combination of, for example, 4G LTE, 5G NR, and 6G communication standards. In some implementations another combination can be used. Carrier aggregation (CA) can include, for example, a scenario in which UE 210 aggregates component carriers from a PCell under MCG 310 and an SCell under MCG 310. Dual connectivity can include, for example, a scenario in which UE 210 connects to cells under MCG 310 and SCG 320.

One or more of the techniques described herein include solutions for determining a CQI associated with a group of CCs. UE 210 and base station 222 can establish a connection using CA that involves a group of CCs. Base station 222 can be configured to operate as one or more types of cell groups (e.g., MCG 310, SCG 320, etc.) and/or types of cells (e.g., PCell, SCell, PSCell, sSCell, etc.). In some implementations, base station 222 can operate cooperatively or in tandem with one or more other base station 222, which can be configured to operate as one or more types of cell groups and/or cells.

As described herein, base station 222 operating as MCG 310 or SCG 320 can allocate BWPs to UE 210 based on a cell-specific subcarrier spacing (SCS), cyclic prefix (CP), and one or more radio resource control (RRC) parameters. BWP switching can be based on RRC signaling, DCI, inactivity timer, SCS configuration, and/or RACH procedure. Inactivity timers can be configured according to a paired or unpaired spectrum BWP configuration. A common downlink and/or uplink BWP can be implemented for UEs in an idle mode, during RRC configuration or reconfiguration, and/or for cell-specific RACH procedures. Additional example of features, operations, information, and procedures are discussed below.

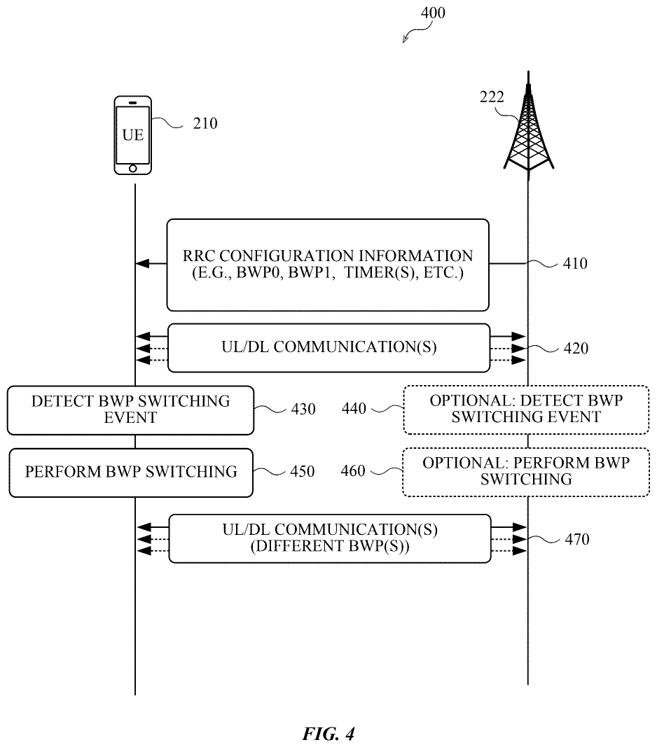

FIG. 4 is a diagram of an example process 400 for enhanced BWP configuration and/or operation according to one or more implementations described herein. As shown, process 400 can be performed by UE 210 and base station 222. Base station 222 can be implemented as one or more base stations 222. Some or all of process 400 can be performed by baseband circuitry of UE 210 and/or baseband circuitry of base station 222. Some or all of process 400 can be performed by one or more other systems or devices, including one or more of the devices of FIG. 2.

Base station 222 can implement one or more cells. Base station 222 can implemented one or more types of cell groups (e.g., MCG 310, SCG 320, etc.) and/or types of cells (e.g., PCell, SCell, PSCell, sSCell, etc.). In some implementations, base station 222 can operate cooperatively, or in tandem, with one or more other base station 222, which can be configured to operate as one or more types of cell groups and/or cells. One or more of the cell groups and/or cells of base station 222 can be implemented as a network energy saving (NES) cell.

Additionally, process 400 can include one or more fewer, additional, differently ordered, and/or arranged operations than those shown in FIG. 4. Some or all of the operations of process 400 can be performed independently, successively, simultaneously, etc., of one or more of the other operations of process 400. As such, the techniques described herein are not limited to the number, sequence, arrangement, timing, etc., of the operations or processes depicted in FIG. 4.

As shown, process 400 can include base station 222 communicating RRC configuration information to UE 210 (block 410). For example, base station 222 can provide UE 210 with RRC configuration information as part of a RRC configuration or reconfiguration procedure. In some implementations, base station 222 can provide UE 210 with the RRC configuration information as part of a RACH procedure. This can include an initial attach procedure or a procedure during which UE 210 transitions from an IDLE mode of operation to an ACTIVE mode of operation.

The RRC configuration information can include configuration information indicating a first BWP (e.g., BWP0), a second BWP (e.g., BWP1), a corresponding timer, and/or one or more additional or alternative type of information. Each BWP can include an uplink BWP, a downlink BWP, or a combination of an uplink BWP and downlink BWP. Some of the RRC configuration information can include cell-specific parameters while other RRC configuration information can include UE-specific parameters. Cell-specific parameters can have the same value for all communications with UEs 210. UE-specific parameters can have different values for different UEs 210 within a cell. The values of UE-specific parameters can be based on one or more factors or conditions, such as UE capabilities, UE location information, signal strength information, cell congestion or signal interference, and more.

The BWPs can each be configured according to a cell-specific SCS and CP of base station 222 (e.g., all BWPs of base station 222 can use the same SCS and CP). Each BWP can also, or alternatively, be configured according to one or more UE-specific RRC parameters or information elements (IEs). Examples of the UE-specific RRC parameters can include one or more of: a downlink bandwidth size, uplink bandwidth size, monitoring periodicity, MCS, number of multiple-input multiple-output layers, scheduling offset, priority indicator, CP, SCS, and more. Other RRC parameters of the RRC configuration information can be cell-specific instead of UE-specific.

The first BWP can operate as an initial BWP for performing a RACH procedure, listening for a wakeup message, a paging message, and so on. The second BWP can include a BWP used during an ACTIVE mode or RRC connected state. The timer can include a duration of time or a delay between switching from one BWP to another BWP. The time can relate to an amount of time for which UE 210 (or a BWP) is inactive. The timer can be referred to herein as a BWP timer, switching timer, BWP switching timer, and so on.

Certain types or categories of BWP configuration parameters, along with one or more exceptions, can be implemented as cell-specific parameters instead of UE-specific parameters. For instance, all RRC parameters used for BWP configuration can be implemented on a cell-specific basis (as opposed to a UE-specific basis) with one or more exception. Examples of such exceptions can include RRC parameters associated with downlink/uplink bandwidth size, PDCCH monitory periodicity, MCS parameters or tables (e.g., a mcs-Table parameter), frequency domain parameters for downlink reception and/or UL transmission (e.g., number of multiple-input multiple-output layers, scheduling offset, priority indicator, CP, subcarrier spacing (SCS), and more.).

An mcs-Table parameter can indicate which MCS table UE 210 is to use PDSCH communications and can correspond to a L1 parameter that can include an ‘MCS-Table-PDSCH parameter. The configuration of a BWP can be based-on timing or a channel type (e.g., a random access channel (RACH) and/or accomplished using radio resource control (RRC) signaling or downlink control information (DCI). There can be several different types of BWPs: Initial BWP, firstActiveBWP, Default BWP, and (regular) BWPs. Type 1 switching can include BWP switching prompted by DCI, while Type 2 switching can include BWP switching prompted by expiration of an inactivity timer, or visa-versa.

Process 400 can include UE 210 and base station 222 sending and receiving uplink and downlink communications to one another (block 420). For example, UE 210 and base station 222 can use the first BWP and the second BWP to communicate with one another. In some implementations, the first BWP can be used as an initial BWP during a RACH procedure and the second BWP can be used as an active BWP (e.g., after the RACH procedure is complete and so long as UE 210 remains active). The first BWP can also, or alternatively, operate as a default BWP (e.g., for when UE 210 transitions to an IDLE mode, after expiration of the timer, etc.). In some implementations, the RRC configuration information can be provided during a RACH procedure. For example, the first BWP and the second BWP can be configured by the same RACH messages of the RACH procedure or by different RACH messages of the RACH procedure.

Process 400 can include UE 210 and/or base station 222 detecting a BWP switching even (blocks 430 and 440). A BWP switching event can include receiving DCI indicating that a BWP switch should occur, expiration of a BWP inactivity timer for a BWP, UL BWP, or DL BWP, transitioning to an IDLE state, transitioning to an ACTIVE state, performing or completing a RACH procedure, entering an RRC connected state, and/or one or more other types of events. The BWP inactivity timer can include a duration of time for which a BWP has been inactive. A BWP inactivity timer can also be referred to herein as a BWP activity timer, and a BWP inactivity timer can be specific to a UL and DL BWP pair, a UL BWP alone, a DL BWP alone, or a combination thereof.

Process 400 can include UE 210 and/or base station 222 performing BWP switching (block 450 and 460). For example, UE 210 and/or base station 222 can switch from one BWP to another BWP in response to a BWP switching event. BTW switching can include transitioning from using one UL and DL BWP pair to using another UL and DL BWP pair, switching from using a UL BWP to using another UL BWP, switching from using a DL BWP to using another DL BWP, or a combination thereof. For example, BWP switching can include switching from one UL BWP to another BWP while continuing to use the same DL BWP as before.

Process 400 can include UE 210 and base station 222 communicating using different BWPs (block 470). For example, UE 210 and base station transitioned from using a first BWP (e.g., BWP0) to using a different BWP (e.g., BWP1) as a result of the BWP switching. UE 210 and base station 222 can continue to communicate with one another using the new BWP(s). As described herein, the BWPs used to communicate can depend on one or more factors or conditions, such as whether UE 210 is in an IDLE or Active state of operation and whether UE 210 is in an RRC connected mode, and more.

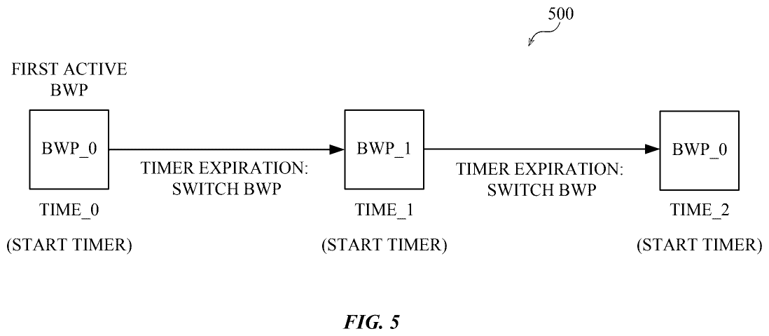

FIG. 5 is a diagram of an example 500 of BWP switching based on timer expiration according to one or more implementations described herein. As shown, example 500 can include TIME_0, TIME_1, and TIME_2. A first time BWP is indicated as BWP_0 and a second BWP is indicated a BWP_1. The first BWP can be implemented as a first active BWP. For example, the first BWP can be used to enable communications between UE 210 and base station 222 while UE 210 is in an ACTIVE mode or RRC connected mode. In response to the first BWP becoming inactive, UE 210 can initiate a timer for switching from the first BWP to the second BWP.

When the first BWP remains inactive for the duration of the time, UE 210 and/or base station 222 can switch from using the first BWP to using the second BWP upon expiration of the timer. Example 500 therefore shows the second BWP (BWP_1) being used at TIME_1. In some implementations, a timers can be initiated when a different BWP begins to be used (e.g., as opposed to when a current BWP becomes inactive). For example, UE 210 and/or base station 222 can begin a timer at TIME_1 when the BWP being used has switched from BWP_0 to BWP_1. Upon expiration of the timer, UE 210 and/or base station 222 can switch from the second BWP (BWP_1) back to the first BWP (BWP_0) at TIME_2. Accordingly, UE 210 and/or base station 222 can switch between two BWPs upon expiration of a BWP timer that can be initiated when a current BWP becomes inactive and/or when BWP switching occurs.

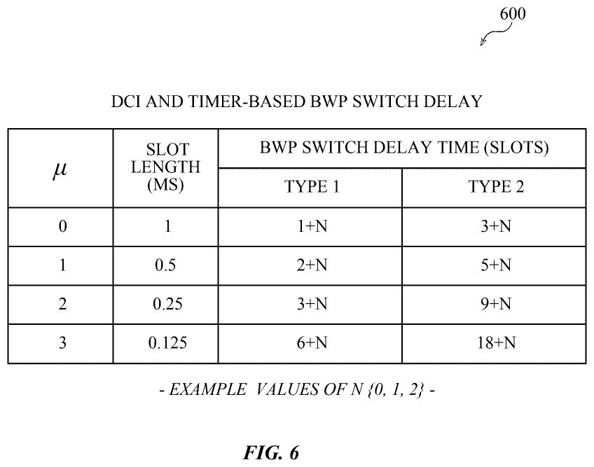

FIG. 6 is a diagram of an example 600 of a table for downlink control information (DCI) and timer-based BWP switching according to one or more implementations described herein. A minimum switching delay can be implemented as a minimum delay for switching between one BWP to another BWP. BWP switch delay can be indicated or configured based on DCI and/or a timer-based BWP switch delay. In some implementations, the duration of a minimum switching delay can be based on UE capability information. For example, UEs 210 of different capabilities can be configured with different minimum switching delays that are based on the capabilities of the UEs 210. In some implementations, the minimum switching delay can be the same for a particular UE 210 in all SCS scenarios (e.g., regardless of the cell-specific SCS implemented by a particular cell). In other implementations, the minimum switching delay can vary based on the cell-specific SCS implemented by a particular cell.

As shown, example 600 can include a Mu column, a slot length in milliseconds (ms) column, a Type 1 BWP switch delay time column, and a Type 2 BWP switch delay time column. Values of the Mu column can include 0, 1, 2, and 3. Values in the sloth length column can include 1 ms, 0.5 ms, 0.25 ms, and 0.125 ms. Values of the Type 1 BWP switch delay time column can include 1+N, 2+N, 3+N, and 6+N. Values of the Type 2 BWP switch delay time column can include 3+N, 5+N, 9+N, and 18+N. Depending on the implementation, the value of N can be one or more of a variety of values, such as 0, 1, or 2. Type 1 can apply to scenarios in which a BWP switch delay depends on UE capabilities. Type 2 can apply to scenarios in which a BWP switch involves changing of SCS, where upon the BWP switch delay can be determined by the smaller SCS between the SCS before the BWP switch and the SCS after the BWP switch.

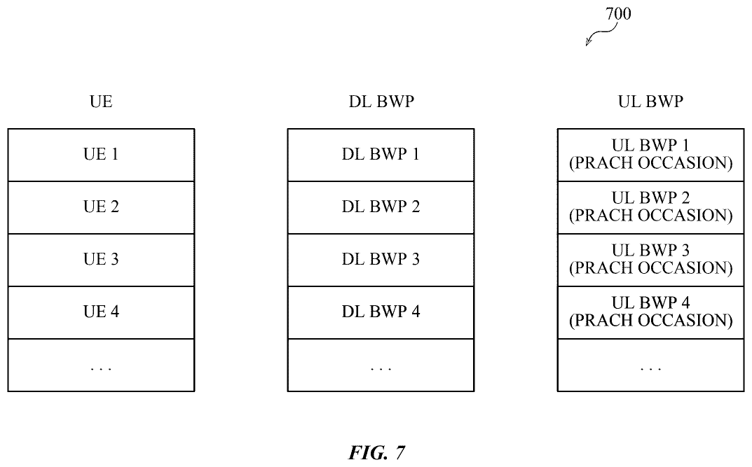

FIG. 7 is a diagram of an example 700 of a BWP configuration with physical random access channel (PRACH) occasions according to one or more implementations described herein. As shown, example 700 can include UEs 210 (UE 1-4 and more), DL BWPs (DL BWP 1-4 and more), and UL BWPs (UL BWP 1-4 and more). The DL BWPs and the UL BWPs can be paired or unpaired. Each UL BWP can include one or more PRACH occasion. Assume that DL BWP 1 and UL BWP 1 are allocated to UE 1. When UE 1 is in an ACTIVE state, UE 1 can use DL BWP 1 and UL BWP 1 to communicated with base station 222.

When UE 1 is in an IDLE state, UE 1 can continue to use UL BWP 1 because UL BWP 1 includes one or more PRACH occasions whereby UE 1 can communicate with base station 222 to perform a RACH procedure, reconnect to base station 222, and transition to an ACTIVE state of operation. In scenarios where UE 1 is using a UL BWP that does not have a PRACH occasion, UE 1 can transition to a UL BWP with a PRACH occasion upon entering an IDLE state or performing a RACH procedure.

There can be couple of reasons that RACH is initiated for UE 210 in an RRC connected mode, like beam failure detection and recovery (BFR), uplink data arrival without scheduling request (SR), and more. One or more of the techniques described herein can include configuring at least one of two BWPs allocated to UE 210 to operate as an initial BWP by being configured with UE-specific parameters consistent with an RRC configured BWP. To avoid UL BWP switching due to a RACH procedure, a UL BWP can be configured with one or more RACH occasions. In some implementations, the RACH occasions can be used commonly by multiple UEs. In some implementations, different RACH occasions can be allocated to different UEs. For example, configuration information, such as parameters of the information element (IE) RACH-ConfigCommon can be moved to the serving cell (e.g., be cell-specific as opposed to BWP-specific). In some implementations, other configuration information can be UE-specific.

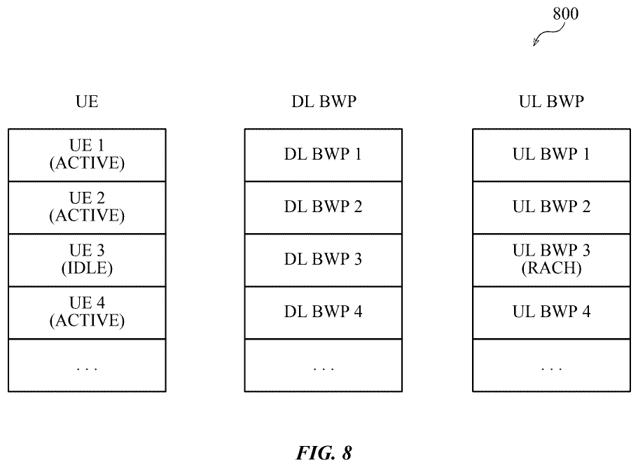

FIG. 8 is a diagram of an example 800 of a BWP configuration with common downlink and uplink BWPS for random access channel (RACH) procedures according to one or more implementations described herein. As shown, example 800 can include UEs 210 (UE 1-4 and more), DL BWPs (DL BWP 1-4 and more), and UL BWPs (UL BWP 1-4 and more). The DL BWPs and the UL BWPs can be paired or unpaired. As shown, UEs 210 (e.g., UE 1-4 and more) can be in an ACTIVE state or an IDLE state. UEs 210. The UL BWPS can include one or more UL BWPs designated for RACH procedures (e.g., UL BWP 3).

Other UL BWPs can be designated for other uses (e.g., non-RACH activities). UL BWP 3 can be a common UL BWP for all UEs 210 performing RACH procedures. Depending on the implementations, the DL BWPs may or may not include a designated DL BWP for RACH procedures. When the DL BWPs do not include a dedicated DL BWP for RACH procedures, UEs 210 can perform RACH procedures using a current active DL BWP allocated to the UE 210 and the UL BWP dedicated to RACH procedures, which can involve the UE 210 switching from a regular or non-RACH UL BWP to the UL BWP dedicated to RACH procedures.

When the DL BWPs include a dedicated DL BWP for RACH procedures, UEs 210 can perform RACH procedures using the DL BWP dedicated for RACH procedures and the UL BWP dedicated to RACH procedures. This can involve the UE 210 switching from an active DL BWP and/or active UL BWP to the DL BWP and the UL BWP dedicated for RACH procedures. When the RACH procedure is complete, the UE 210 can switch to a DL BWP and/or UL BWP that is not dedicated for RACH procedures.

One or more of the techniques described herein can manage DL BWP switching for paired spectrum BWPs in one or more of the following ways. PRACH resources (e.g., RACH occasions (ROs) and/or preambles for RACH procedures) can be allocated among RRC connected UEs 210 via according to current active DL BWPs. For example a sequence of locationAndBandwidth can be configured in a ServingCellConfigCommon IE, representing all DL BWPs in a serving cell. The values of the ConfDownlinkBWPs IE can be set to {6610, 13775, 17605, 21175}, partitioning of PRACH resources to four UEs 210. As such, The UE 210 using a current active DL BWP related to 13755 can pick corresponding RACH resource associated with the 13755 value. This can enable base station 222 to determine which DL BWP to use for transmitting a corresponding Msg2 RACH message. Without such an approach, base station 222 may receive a Msg1 RACH message but not be able to determine which DL BWP to use for transmitting the Msg2 RACH message.

Additionally, or alternatively, base station 222 can provide a common search space (CSS) (which can be configured by an IE, such as the ra-SearchSpace IE) on all DL BWPs on the primary cell. When a current active DL BWP contains initial DL BWP, a frequency domain resource allocation (FDRA) in downlink control information (DCI) can be addressed with a random access radio network temporary identifier (RA-RNTI). The FDRA can be determined based on a size of the initial DL BWP. Consequently, when UEs 210 transmitting a Msg1 RACH message from a given UL BWP, the UEs 210 can switch to the same DL BWP (which has the same BWP ID as the UL BWP). Base station 222 can therefore send multiple random access response (RAR) messages in a single media access control (MAC) MAC protocol data unit (PDU), addressed using the same RA-RNTI, corresponding to different UEs that initiated the random access procedure in the same RACH opportunity.

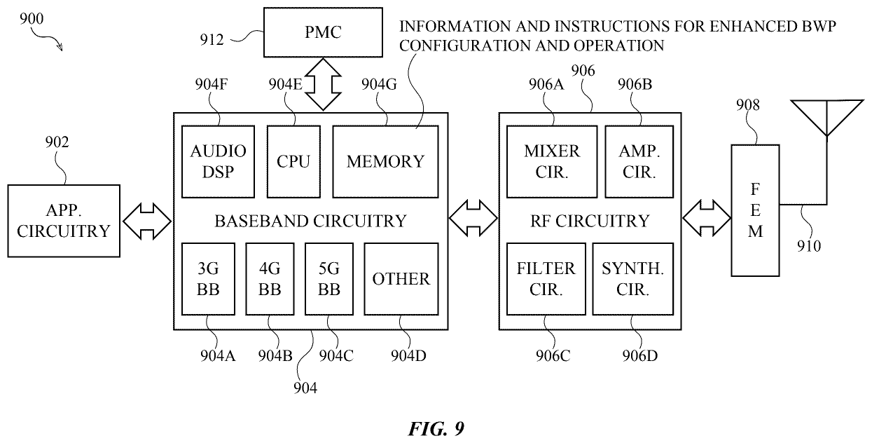

FIG. 9 is a diagram of an example of components of a device according to one or more implementations described herein. In some implementations, device 900 can include application circuitry 902, baseband circuitry 904, RF circuitry 906, front-end module (FEM) circuitry 908, one or more antennas 910, and power management circuitry (PMC) 912 coupled together at least as shown. In some implementations, device 900 can include fewer elements (e.g., a RAN node may not utilize application circuitry 902 and can instead include a processor/controller to process data received from a core network. In some implementations, device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for cloud-RAN (C-RAN) implementations).

Application circuitry 902 can include one or more application processors. For example, application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 900. In some implementations, processors of application circuitry 902 can process data packets received from a core network.

Baseband circuitry 904 can include circuitry such as, but not limited to, one or more single-core or multi-core processors. Baseband circuitry 904 can include one or more baseband processors or control logic to process baseband signals received from a receive signal path of RF circuitry 906 and to generate baseband signals for a transmit signal path of RF circuitry 906. Baseband circuity 904 can interface with application circuitry 902 for generation and processing of the baseband signals and for controlling operations of RF circuitry 906. For example, in some implementations, baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, 7G, etc.). Baseband circuitry 904 (e.g., one or more of baseband processors 904A-D) can handle various radio control functions that enable communication with one or more radio networks via RF circuitry 906. In other implementations, some or all of the functionality of baseband processors 904A-D can be included in modules stored in memory 904G and executed via a central processing unit (CPU) 904E. The radio control functions can include, but are not limited to, signal modulation/demodulation, encoding/decoding, radio frequency shifting, etc. In some implementations, modulation/demodulation circuitry of baseband circuitry 904 can include Fast-Fourier Transform (FFT), precoding, or constellation mapping/de-mapping functionality. In some implementations, encoding/decoding circuitry of baseband circuitry 904 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 904G can receive and/or store information and instructions for enhanced bandwidth part (BWP) configuration and operation. Base station 222 can allocate BWPs to UEs 210 based on a cell-specific subcarrier spacing (SCS), cyclic prefix (CP), and one or more radio resource control (RRC) parameters. BWP switching can be based on RRC signaling, DCI, inactivity timer, SCS configuration, and/or RACH procedure. Inactivity timers can be configured according to a paired or unpaired spectrum BWP configuration. A common downlink and/or uplink BWP can be implemented for UEs in an idle mode, during RRC configuration or reconfiguration, and/or for cell-specific RACH procedures. Many other aspects and examples are also described herein.

In some implementations, baseband circuitry 904 can include one or more audio digital signal processor(s) (DSP) 904F. Audio DSP 904F can include elements for compression/decompression and echo cancellation and can include other suitable processing elements in other implementations. Components of baseband circuitry 904 can be suitably combined in a single chip, a single chipset, or disposed on a same circuit board in some implementations. In some implementations, some or all of the constituent components of baseband circuitry 904 and application circuitry 902 can be implemented together such as, for example, on a system on a chip (SOC).

In some implementations, baseband circuitry 904 can provide for communication compatible with one or more radio technologies. For example, in some implementations, baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, RF circuitry 906 can include switches, filters, amplifiers, etc., to facilitate the communication with the wireless network. RF circuitry 906 can include a receive signal path which can include circuitry to down-convert RF signals received from FEM circuitry 908 and provide baseband signals to baseband circuitry 904. RF circuitry 906 can also include a transmit signal path which can include circuitry to up-convert baseband signals provided by baseband circuitry 904 and provide RF output signals to FEM circuitry 908 for transmission.

In some implementations, the receive signal path of RF circuitry 906 can include mixer circuitry 906A, amplifier circuitry 906B and filter circuitry 906C. In some implementations, the transmit signal path of RF circuitry 906 can include filter circuitry 906C and mixer circuitry 906A. RF circuitry 906 can also include synthesizer circuitry 906D for synthesizing a frequency for use by mixer circuitry 906A of the receive signal path and the transmit signal path. In some implementations, mixer circuitry 906A of the receive signal path can be configured to down-convert RF signals received from FEM circuitry 908 based on the synthesized frequency provided by synthesizer circuitry 906D. Amplifier circuitry 906B can be configured to amplify the down-converted signals and filter circuitry 906C can be a low-pass filter (LPF) or band-pass filter (BPF) configured to remove unwanted signals from the down-converted signals to generate output baseband signals. Output baseband signals can be provided to baseband circuitry 904 for further processing. In some implementations, the output baseband signals can be zero-frequency baseband signals, although this may not be a requirement. In some implementations, mixer circuitry 906A of the receive signal path can comprise passive mixers, although the scope of the implementations is not limited in this respect.

In some implementations, mixer circuitry 906A of the transmit signal path can be configured to up-convert input baseband signals based on the synthesized frequency provided by synthesizer circuitry 906D to generate RF output signals for FEM circuitry 908. The baseband signals can be provided by baseband circuitry 904 and can be filtered by filter circuitry 906C. In some implementations, mixer circuitry 906A of the receive signal path and mixer circuitry 906A of the transmit signal path can include two or more mixers and can be arranged for quadrature down conversion and up conversion, respectively. In some implementations, mixer circuitry 906A of the receive signal path and mixer circuitry 906A of the transmit signal path can include two or more mixers and can be arranged for image rejection. In some implementations, mixer circuitry 906A of the receive signal path and mixer circuitry 906A of the transmit signal path can be arranged for direct down conversion and direct up conversion, respectively. In some implementations, mixer circuitry 906A of the receive signal path and mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 906 can include analog-to-digital converter (ADC) and digital-to-analog converter (DAC) circuitry and baseband circuitry 904 can include a digital baseband interface to communicate with RF circuitry 906.

In some dual-mode implementations, a separate radio integrated circuitry can be provided for processing signals for each spectrum, although the scope of the implementations is not limited in this respect. In some implementations, synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

Synthesizer circuitry 906D can be configured to synthesize an output frequency for use by mixer circuitry 906A of RF circuitry 906 based on a frequency input and a divider control input. In some implementations, synthesizer circuitry 906D can be a fractional N/N+1 synthesizer. In some implementations, frequency input can be provided by a voltage-controlled oscillator (VCO). Divider control input can be provided by either baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of RF circuitry 906 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 906 can include an in-phase/quadrature (I/Q)/polar converter.

FEM circuitry 908 can include a receive signal path which can include circuitry configured to operate on RF signals received from one or more antennas 910, amplify the received signals and provide the amplified versions of the received signals to RF circuitry 906 for further processing. FEM circuitry 908 can also include a transmit signal path which can include circuitry configured to amplify signals for transmission provided by RF circuitry 906 for transmission by one or more of the one or more antennas 910. In various implementations, the amplification through the transmit or receive signal paths can be done solely in RF circuitry 906, solely in FEM circuitry 908, or in both RF circuitry 906 and FEM circuitry 908.

In some implementations, FEM circuitry 908 can include a transmit/receive switch to switch between transmit mode and receive mode operation. FEM circuitry 908 can include a receive signal path and a transmit signal path. The receive signal path of FEM circuitry 908 can include a low noise amplifier to amplify received RF signals and provide the amplified received RF signals as an output (e.g., to RF circuitry 906). The transmit signal path of FEM circuitry 908 can include a power amplifier to amplify input RF signals (e.g., provided by RF circuitry 906), and one or more filters to generate RF signals for subsequent transmission (e.g., by one or more of one or more antennas 910).

In some implementations, PMC 912 can manage power provided to baseband circuitry 904. In particular, PMC 912 can control power-source selection, voltage scaling, battery charging, or direct current (DC) to DC (DC-to-DC) conversion. PMC 912 can often be included when device 900 is capable of being powered by a battery, for example, when device 900 is included in a UE. PMC 912 can increase the power conversion efficiency while providing desirable implementation size and heat dissipation characteristics.

While FIG. 9 shows PMC 912 coupled only with baseband circuitry 904. However, in other implementations, PMC 912 can be additionally or alternatively coupled with, and perform similar power management operations for, other components such as, but not limited to, application circuitry 902, RF circuitry 906, or FEM circuitry 908.

In some implementations, PMC 912 can control, or otherwise be part of, various power saving mechanisms of device 900. For example, if device 900 is in an RRC_Connected state, where device 900 is still connected to the RAN node as device 900 expects to receive traffic shortly, then device 900 can enter a state known as discontinuous reception mode (DRX) after a period of inactivity. During this state, device 900 can power down for brief intervals of time and thus save power.

If there is no data traffic activity for an extended period of time, then device 900 can transition off to an RRC_Idle state, where device 900 disconnects from the network and does not perform operations such as channel quality feedback, handover, etc. Device 900 can go into a very low power state and device 900 can perform paging where again device 900 periodically can wake up to listen to the network and then power down again. Device 900 may not receive data in this state; in order to receive data, device 900 can transition back to RRC_Connected state.

An additional power saving mode can allow a device to be unavailable to the network for periods longer than a paging interval (ranging from seconds to a few hours). During this time, the device 900 can be unreachable to the network and can power down completely. Any data sent during this time can incur a large delay and device 900 can assume the delay is acceptable.

Processors of application circuitry 902 and processors of baseband circuitry 904 can be used to execute elements of one or more instances of a protocol stack. For example, processors of baseband circuitry 904, alone or in combination, can be used execute Layer 3, Layer 2, or Layer 1 functionality, while processors of baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

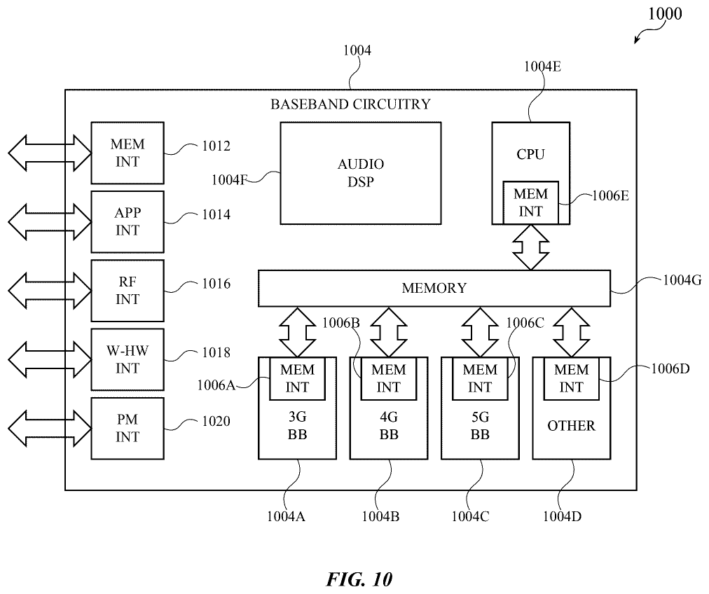

FIG. 10 is a diagram of example interfaces 1000 of baseband circuitry according to one or more implementations described herein. One or more components or features of example interfaces 1000 can correspond to one or more components or features described above or elsewhere. Baseband circuitry 1004 can comprise processors 1004A, 1004B, 1004C, 1004D, and 1004E and a memory 1004G utilized by said processors. Each of processors 1004A, 1004B, 1004C, 1004D, and 1004E can include a memory interface, 1006A, 1006B, 1006C, 1006D, and 1006E, respectively, to send/receive data to/from memory 1004G. Baseband circuitry can be a component of a UE and/or another type of device or system capable of transmitting and/or receiving wireless signals.

Baseband circuitry 1004 can further include one or more interfaces to communicatively couple to other circuitries/devices, such as memory interface 1012 (e.g., an interface to send/receive data to/from memory external to baseband circuitry 1004), an application circuitry interface 1014 (e.g., an interface to send/receive data to/from the application circuitry as described herein), an RF circuitry interface 1016, a wireless hardware connectivity interface 1018 (e.g., an interface to send/receive data to/from near field communication components, Bluetooth® components (e.g., Bluetooth® Low Energy), Wi-Fi® components, and other communication components), and a power management interface 1020 (e.g., an interface to send/receive power or control signals to/from a PMC).

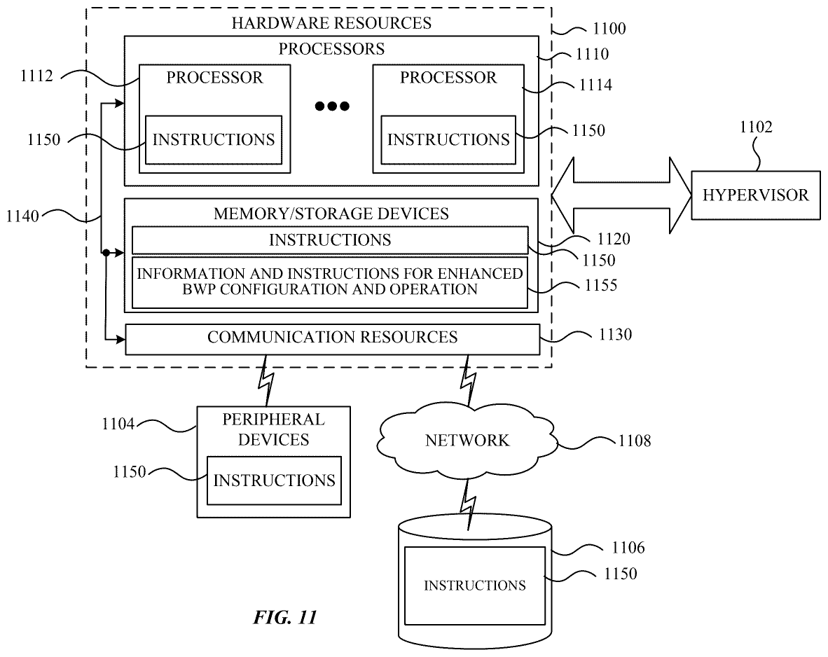

FIG. 11 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors 1110 (or processor cores), one or more memory/storage devices 1120, and one or more communication resources 1130, each of which can be communicatively coupled via a bus 1140. For implementations where node virtualization or network function virtualization is utilized, a hypervisor can be executed to provide an execution environment for one or more network slices/sub-slices to utilize hardware resources 1100. Hardware resources 1100 can interact with hypervisor 1102. For example, hypervisor 1102 can schedule or otherwise manage hardware resource 1100.

Processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1112 and a processor 1114.

Memory/storage devices 1120 can include main memory, disk storage, or any suitable combination thereof. Memory/storage devices 1120 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1120 receive and/or store information and instructions 1155 for enhanced bandwidth part (BWP) configuration and operation. Base station 222 can allocate BWPs to UEs 210 based on a cell-specific subcarrier spacing (SCS), cyclic prefix (CP), and one or more radio resource control (RRC) parameters. BWP switching can be based on RRC signaling, DCI, inactivity timer, SCS configuration, and/or RACH procedure. Inactivity timers can be configured according to a paired or unpaired spectrum BWP configuration. A common downlink and/or uplink BWP can be implemented for UEs in an idle mode, during RRC configuration or reconfiguration, and/or for cell-specific RACH procedures. Many other aspects and examples are also described herein.

Communication resources 1130 can include interconnection or network interface components or other suitable devices to communicate with one or more peripheral devices 1104 or one or more databases 1106 via a network 1108. For example, communication resources 1130 can include wired communication components (e.g., for coupling via a universal serial bus), cellular communication components, near field communication components, Bluetooth® components (e.g., Bluetooth® Low Energy), Wi-Fi® components, and other communication components.

Instructions 1150A, 1150B, 1150C, 1150D, and/or 1150E can comprise software, a program, an application, an applet, an app, or other executable code for causing at least any of processors 1110 to perform any one or more of the methodologies discussed herein. Instructions 1150 can reside, completely or partially, within at least one of processors 1110 (e.g., within a cache memory), memory/storage devices 1120, or any suitable combination thereof. Furthermore, any portion of instructions 1150A-E can be transferred to hardware resources 1100 from any combination of peripheral devices 1104 or databases 1106. Accordingly, memory of processors 1110, memory/storage devices 1120, peripheral devices 1104, and databases 1106 are examples of computer-readable and machine-readable media.

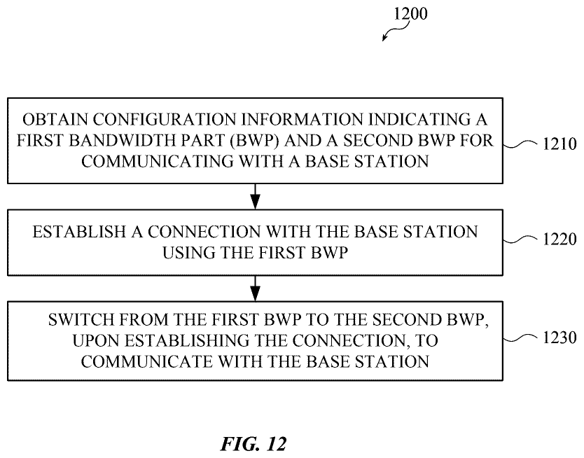

FIG. 12 is a diagram of an example process 1200 for enhanced BWP configuration and/or operation according to one or more implementations described herein. As shown, process 1200 can be implemented by UE 210 and/or baseband circuitry 904. In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to the number, sequence, arrangement, timing, etc., of the operations or processes depicted in FIG. 12.

As shown, process 1200 can include obtaining configuration information indicating a first bandwidth part (BWP) and a second BWP for communicating with a base station (block 1210). Process 1200 can include establishing a connection with the base station using the first BWP (block 1220). Process 1200 can include switching from the first BWP to the second BWP, upon establishing the connection, to communicate with the base station (block 1230).

One or more of the examples described herein can also, or alternatively, be part of process 1200.

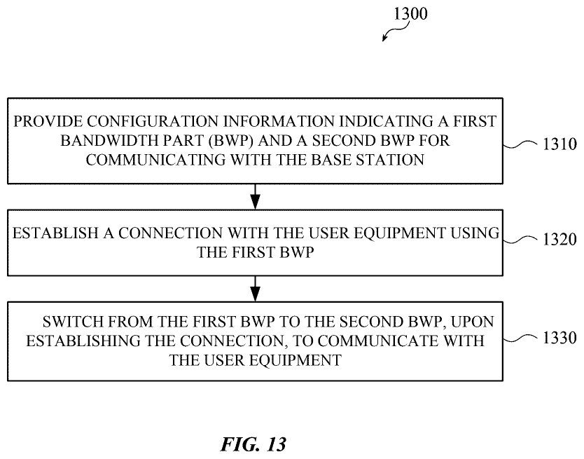

FIG. 13 is a diagram of an example process 1300 for enhanced BWP configuration and/or operation according to one or more implementations described herein. As shown, process 1300 can be implemented by base station 222 and/or baseband circuitry 904. In some implementations, some or all of process 1300 can be performed by one or more other systems or devices, including one or more of the devices of FIG. 2. Additionally, process 1300 can include one or more fewer, additional, differently ordered and/or arranged operations than those shown in FIG. 13. In some implementations, some or all of the operations of process 1300 can be performed independently, successively, simultaneously, etc., of one or more of the other operations of process 1300. As such, the techniques described herein are not limited to the number, sequence, arrangement, timing, etc., of the operations or processes depicted in FIG. 13.

As shown, process 1300 can include providing configuration information indicating a first bandwidth part (BWP) and a second BWP for communicating with the user equipment (block 1310). Process 1300 can include establishing a connection with the user equipment using the first BWP (block 1320). Process 1300 can include switching from the first BWP to the second BWP, upon establishing the connection, to communicate with the user equipment (block 1330). One or more of the examples described herein can also, or alternatively, be part of process 1300.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a method performed by a user equipment (UE), the method can include: obtaining configuration information indicating a first bandwidth part (BWP) and a second BWP for communicating with a base station; establishing a connection with the base station using the first BWP; and switching from the first BWP to the second BWP, upon establishing the connection, to communicate with the base station.

In example 2, which can also include one or more of the examples described herein, the configuration information can include an indication of a single subcarrier spacing (SCS) and a single cyclic prefix (CP) applied commonly among BWPs used for communicating with the base station.

In example 3, which can also include one or more of the examples described herein, the configuration information is obtained from a physical broadcast channel (PBCH) with a signal synchronization block (SSB) indicating a master information block (MIB) can include the indication of the SCS and the CP.

In example 4, which can also include one or more of the examples described herein, radio resource control (RRC) parameters are obtained for communicating with the base station, the RRC parameters can include cell-specific RRC parameters and UE-specific, and the cell-specific RRC parameters can include all the RRC parameters except for: a UL bandwidth size, a DL bandwidth size, a UL/DL bandwidth size, a monitoring periodicity for a physical DL control channel (PDCCH), a modulation and coding scheme (MCS) table, one or more frequency domain parameters for DL reception and UL transmission, a maximum number of multiple-input multiple-output (MIMO) layers, a minimum scheduling offset, a priority indicator, or a combination thereof.

In example 5, which can also include one or more of the examples described herein, the first BWP and the second BWP each can include an UL BWP and a DL BWP of a paired spectrum, the UL BWP and the DL BWP of the first BWP are associated with a first activity timer, and the UL BWP and the DL BWP of the second BWP are associated with a second activity timer.

In example 6, which can also include one or more of the examples described herein, the first activity timer is started or restarted in response to switching from the second BWP to the first BWP, UL activity on the first BWP, or DL activity on the first BWP, expiration of the first activity timer is configured to trigger BWP switching from the first BWP to the second BWP, and the second activity timer is started or restarted in response switching from the first BWP to the second BWP, UL activity on the second BWP, or DL activity on the second BWP, and expiration of the second activity timer is configured to trigger BWP switching from the second BWP to the first BWP.

In example 7, which can also include one or more of the examples described herein, the first BWP can include an initial BWP for use while the UE is in an RRC IDLE state, and the second BWP can include an active BWP for use while the UE is in an RRC CONNECTED state.

In example 8, which can also include one or more of the examples described herein, the active BWP can include an active DL BWP.

In example 9, which can also include one or more of the examples described herein, the first BWP can include a first UL BWP and a first DL BWP, the second BWP can include a second UL BWP and a second DL BWP of an unpaired spectrum, the UL BWP of the first BWP is associated with a first UL activity timer, the DL BWP of the first BWP is associated with a first DL activity timer, the UL BWP of the second BWP is associated with a second UL activity timer, and the DL BWP of the second BWP is associated with a second DL activity timer.

In example 10, which can also include one or more of the examples described herein, the first UL activity timer is configured to run when the UL BWP of the first BWP is being used, the first DL activity timer is configured to run when the DL BWP of the first BWP is being used, the second UL activity timer is configured to run when the UL BWP of the second BWP is being used, and the second DL activity timer is configured to run when the DL BWP of the second BWP is being used.

In example 11, which can also include one or more of the examples described herein, the first UL activity timer and the first DL activity timer are configured to operate independent of one another, and the second UL activity timer and the second DL activity timer are configured to operate independent of one another.

In example 12, which can also include one or more of the examples described herein, the first UL activity timer is started or restarted in response to switching from the second UL BWP to the first UL BWP or UL activity on the first UL BWP, expiration of the first UL activity timer is configured to trigger BWP switching from the first UL BWP to the second UL BWP, the second UL activity timer is started or restarted in response to switching from the first UL BWP to the second UL BWP or UL activity on the second UL BWP, and expiration of the second UL activity timer is configured to trigger BWP switching from the second UL BWP to the first UL BWP.

In example 13, which can also include one or more of the examples described herein, the first DL activity timer is started or restarted in response to switching from the second DL BWP to the first DL BWP or DL activity on the first DL BWP, expiration of the first DL activity timer is configured to trigger BWP switching from the first DL BWP to the second DL BWP, the second DL activity timer is started or restarted in response to switching from the first DL BWP to the second DL BWP or DL activity on the second DL BWP, and expiration of the second DL activity timer is configured to trigger BWP switching from the second DL BWP to the first DL BWP.

In example 14, which can also include one or more of the examples described herein, the method can include detecting a BWP switching event; and performing BWP switching in response to the BWP switching event.

In example 15, which can also include one or more of the examples described herein, the BWP switching event can include at least one of: expiration of a first activity timer of the first BWP, expiration of a second activity timer of the first BWP or obtaining downlink control information (DCI) can include an indication to perform BWP switching.

In example 16, which can also include one or more of the examples described herein, a minimum switching delay is implemented for switching between the first BWP and the second BWP.

In example 17, which can also include one or more of the examples described herein, the minimum switching delay is based on: user equipment (UE) capability information, a number of slots associated with a cell-specific subcarrier spacing (SCS), a number of slots associated with an SCS and modified by an additional number of candidate slots, or a combination thereof.

In example 18, which can also include one or more of the examples described herein, the first BWP can include a first UL BWP and a first DL BWP, the first UL BWP is configured to operate as an initial UL BWP for a plurality of UEs based on a plurality of physical random access channel (PRACH) occasions of the first UL BWP, and the configuration information can include an indication of a particular PRACH occasion, of the plurality of PRACH occasions, allocated to the UE.

In example 19, which can also include one or more of the examples described herein, the initial BWP is configured to be used for RACH procedures.

In example 20, which can also include one or more of the examples described herein, the method can include: receiving an indication of at least one UE-specific physical random access channel (PRACH) resource allocated to the UE from a plurality of UE-specific PRACH resources allocated to UEs and using the at least one UE-specific PRACH resource to perform a RACH procedure.

In example 21, which can also include one or more of the examples described herein, the at least one PRACH resource can include: a UE-specific random access channel (RACH) occasion (RO), a UE-specific a preamble, or a combination thereof.

In example 22, which can also include one or more of the examples described herein, the method can include: receiving an indication of a common search space (CSS) of a DL BWP; when an active DL BWP includes an initial DL BWP, a frequency domain resource allocation (FDRA) in downlink control information (DCI) addressed with a random access radio network temporary identifier (RA-RNTI) is determined by a size of the initial DL BWP, when the active DL BWP does not include the initial DL BWP, and the FDRA in the DCI addressed with the RA-RNTI is determined by the size of the active DL BWP.

In example 23, which can also include one or more of the examples described herein, a method can further comprising: communicating UE capability information configured to indicate whether the UE supports simultaneous BWP switching, in response to DCI and/or in response to activity timer expiration, across different component carriers (CC) in a carrier aggregation (CA) scenario; and when the UE does not support simultaneous BWP switching, communicating UE capability information configured to indicate whether the UE supports sequential BWP switching, in response to DCI and/or in response to activity timer expiration, across different CC in a CA scenario.

In example 24, which can also include one or more of the examples described herein, a user equipment (UE) can include: one or more processors configured to: obtain configuration information indicating a first bandwidth part (BWP) and a second BWP for communicating with a base station establish a connection with the base station using the first BWP; and switch from the first BWP to the second BWP, upon establishing the connection, to communicate with the base station.

In example 25, which can also include one or more of the examples described herein, baseband circuitry can include: one or more processors configured to: obtain configuration information indicating a first bandwidth part (BWP) and a second BWP for communicating with a base station establish a connection with the base station using the first BWP; and switch from the first BWP to the second BWP, upon establishing the connection, to communicate with the base station.

In example 26, which can also include one or more of the examples described herein, a base station can include: one or more processors configured to: obtain configuration information indicating a first bandwidth part (BWP) and a second BWP for communicating with a base station establish a connection with the base station using the first BWP; and switch from the first BWP to the second BWP, upon establishing the connection, to communicate with the base station.

In example 27, which can also include one or more of the examples described herein, a base station can include: a memory configured to store one or more instructions; and one or more processors. The one or more processors can be configured to, when executing the one or more instructions, cause the base station to: provide configuration information indicating a first bandwidth part (BWP) and a second BWP for communicating with the base station establish a connection with the base station using the first BWP; and switch from the first BWP to the second BWP, upon establishing the connection, to communicate with the base station.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A method performed by a user equipment (UE), the method comprising:
obtaining configuration information indicating a first bandwidth part (BWP) and a second BWP for communicating with a base station;
determining, based on the configuration information, a common subcarrier spacing (SCS) and a common cyclic prefix (CP) to be applied for communications with the base station via any BWPs used for communication with the base station;
communicating with the base station using the first BWP, according to the common SCS and the common CP; and
in response to detecting a BWP switching event, switching from the first BWP to the second BWP to communicate with the base station using the second BWP, according to the common SCS and the common CP.

2. The method of claim 1, wherein the configuration information is obtained from a physical broadcast channel (PBCH) with a signal synchronization block (SSB) indicating a master information block (MIB) comprising the indication of the common SCS and the common CP.

3. The method of claim 1, wherein radio resource control (RRC) parameters are obtained for communicating with the base station, the RRC parameters comprising cell-specific RRC parameters and UE-specific RRC parameters, the cell-specific RRC parameters comprising all the RRC parameters except for:
a UL bandwidth size;
a DL bandwidth size;
a UL/DL bandwidth size;
a monitoring periodicity for a physical DL control channel (PDCCH);
a modulation and coding scheme (MCS) table;
one or more frequency domain parameters for DL reception and UL transmission;
a maximum number of multiple-input multiple-output (MIMO) layers;
a minimum scheduling offset;
a priority indicator; or
or a combination thereof.

4. The method of claim 1, wherein:
the first BWP and the second BWP each comprise an UL BWP and a DL BWP of a paired spectrum;
the UL BWP and the DL BWP of the first BWP are associated with a first activity timer; and
the UL BWP and the DL BWP of the second BWP are associated with a second activity timer.

5. The method of claim 4, wherein:
the first activity timer is started or restarted in response to switching from the second BWP to the first BWP, UL activity on the first BWP, or DL activity on the first BWP;
expiration of the first activity timer is configured to trigger BWP switching from the first BWP to the second BWP;
the second activity timer is started or restarted in response switching from the first BWP to the second BWP, UL activity on the second BWP, or DL activity on the second BWP; and
expiration of the second activity timer is configured to trigger BWP switching from the second BWP to the first BWP.

6. The method of claim 5, wherein:
the first BWP comprises an initial BWP for use while the UE is in an RRC IDLE state; and
the second BWP comprises an active BWP for use while the UE is in an RRC CONNECTED state.

7. The method of claim 6, wherein the active BWP comprises an active DL BWP.

8. The method of claim 1, wherein:
the first BWP comprises a first UL BWP and a first DL BWP;
the second BWP comprises a second UL BWP and a second DL BWP of an unpaired spectrum;
the UL BWP of the first BWP is associated with a first UL activity timer;
the DL BWP of the first BWP is associated with a first DL activity timer;
the UL BWP of the second BWP is associated with a second UL activity timer; and
the DL BWP of the second BWP is associated with a second DL activity timer.

9. The method of claim 8, wherein:
the first UL activity timer is configured to run when the UL BWP of the first BWP is being used;
the first DL activity timer is configured to run when the DL BWP of the first BWP is being used;
the second UL activity timer is configured to run when the UL BWP of the second BWP is being used; and
the second DL activity timer is configured to run when the DL BWP of the second BWP is being used.

10. The method of claim 9, wherein:
the first UL activity timer and the first DL activity timer are configured to operate independent of one another; and
the second UL activity timer and the second DL activity timer are configured to operate independent of one another.

11. The method of claim 10, wherein:
the first UL activity timer is started or restarted in response to switching from the second UL BWP to the first UL BWP or UL activity on the first UL BWP;
expiration of the first UL activity timer is configured to trigger BWP switching from the first UL BWP to the second UL BWP;
the second UL activity timer is started or restarted in response to switching from the first UL BWP to the second UL BWP or UL activity on the second UL BWP; and
expiration of the second UL activity timer is configured to trigger BWP switching from the second UL BWP to the first UL BWP.

12. The method of claim 11, wherein:
the first DL activity timer is started or restarted in response to switching from the second DL BWP to the first DL BWP or DL activity on the first DL BWP;
expiration of the first DL activity timer is configured to trigger BWP switching from the first DL BWP to the second DL BWP;
the second DL activity timer is started or restarted in response to switching from the first DL BWP to the second DL BWP or DL activity on the second DL BWP; and
expiration of the second DL activity timer is configured to trigger BWP switching from the second DL BWP to the first DL BWP.

13. The method of claim 1, wherein the BWP switching event comprises at least one of:
expiration of a first activity timer of the first BWP;
expiration of a second activity timer of the first BWP;
obtaining downlink control information (DCI) comprising an indication to perform BWP switching; or
transitioning from an RRC IDLE state to an RRC CONNECTED state.

14. The method of claim 1, wherein a minimum switching delay is implemented for switching between the first BWP and the second BWP.

15. The method of claim 14, wherein the minimum switching delay is based on:
user equipment (UE) capability information;
a number of slots associated with a cell-specific subcarrier spacing (SCS);
a number of slots associated with an SCS and modified by an additional number of candidate slots; or
a combination thereof.

16. The method of claim 1, wherein:
the first BWP comprises a first UL BWP and a first DL BWP;
the first UL BWP is configured to operate as an initial UL BWP for a plurality of UEs based on a plurality of physical random access channel (PRACH) occasions of the first UL BWP; and
the configuration information comprises an indication of a particular PRACH occasion, of the plurality of PRACH occasions, allocated to the UE.

17. The method of claim 16, wherein the initial BWP is configured to be used for RACH procedures.

18. The method of claim 1, further comprising:
receiving an indication of at least one UE-specific physical random access channel (PRACH) resource allocated to the UE from a plurality of UE-specific PRACH resources allocated to UEs; and
using the at least one UE-specific PRACH resource to perform a RACH procedure.

19. The method of claim 18, wherein the at least one PRACH resource comprises:
a UE-specific random access channel (RACH) occasion (RO);
a UE-specific a preamble; or
or a combination thereof.

20. The method of claim 1, further comprising:
receiving an indication of a common search space (CSS) of a DL BWP;
wherein when an active DL BWP includes an initial DL BWP, a frequency domain resource allocation (FDRA) in downlink control information (DCI) addressed with a random access radio network temporary identifier (RA-RNTI) is determined by a size of the initial DL BWP; and
wherein when the active DL BWP does not include the initial DL BWP, the FDRA in the DCI addressed with the RA-RNTI is determined by the size of the active DL BWP.

21. The method of claim 1, further comprising:
communicating UE capability information configured to indicate whether the UE supports simultaneous BWP switching, in response to DCI and/or in response to activity timer expiration, across different component carriers (CC) in a carrier aggregation (CA) scenario; and
when the UE does not support simultaneous BWP switching, communicating UE capability information configured to indicate whether the UE supports sequential BWP switching, in response to DCI and/or in response to activity timer expiration, across different CC in a CA scenario.

22. A user equipment (UE) comprising:
one or more processors configured to:
obtain configuration information indicating a first bandwidth part (BWP) and a second BWP for communicating with a base station;
determine, based on the configuration information, a common subcarrier spacing (SCS) and a common cyclic prefix (CP) to be applied for communications with the base station via any BWPs used for communication with the base station;
communicate with the base station using the first BWP, according to the common SCS and the common CP; and
in response to detecting a BWP switching event, switch from the first BWP to the second BWP, to communicate with the base station using the second BWP, according to the common SCS and the common CP.

23. Baseband circuitry comprising:
a memory configured to store one or more instructions; and
one or more processors configured to, when executing the one or more instructions, cause a user equipment (UE) to:
obtain configuration information indicating a first bandwidth part (BWP) and a second BWP for communicating with a base station;
determine, based on the configuration information, a common subcarrier spacing (SCS) and a common cyclic prefix (CP) to be applied for communications with the base station via any BWPs used for communication with the base station;
communicate with the base station using the first BWP, according to the common SCS and the common CP; and
in response to detecting a BWP switching event, switch from the first BWP to the second BWP, to communicate with the base station using the second BWP, according to the common SCS and the common CP.
